(19) United States
(12) Patent Application Publication
(10) Pub. No.: US 2014/0016654 A1
(43) Pub. Date: Jan. 16, 2014

(54) CAN COMMUNICATION SYSTEM, CAN TRANSMISSION APPARATUS, CAN RECEPTION APPARATUS, AND CAN COMMUNICATION METHOD

(71) Applicant: Masataka YAKASHIRO, Kanagawa (JP)

(72) Inventor: Masataka YAKASHIRO, Kanagawa (JP)

(73) Assignee: RENESAS ELECTRONICS CORPORATION, Kawasaki-shi, Kanagawa (JP)

(21) Appl. No.: 14/006,892

(22) PCT Filed: Feb. 24, 2012
(86) PCT No.: PCT/JP2012/001281

§ 371 Date: Sep. 23, 2013

(30) Foreign Application Priority Data
Mar. 31, 2011 (JP) 2011-077032

(51) Int. Cl. H04J 3/06

(52) U.S. Cl. CPC H04J 3/0638
USPC 370/516

(57) ABSTRACT

A CAN communication system of the present invention includes: a transmission apparatus that transmits transmission data instead of the bit data protocol, the transmission data being data in which a stuff bit having an inverted value of the same logical value has been inserted next to the predetermined number of continuous bits having the same logical value in the bit data; a reception apparatus that synchronizes transmission and reception of the transmission data to and from the transmission apparatus according to detection of an edge from the second logical value to the first logical value in the transmission data transmitted from the transmission apparatus. The transmission apparatus has a transmission control unit that rewrites to the first logical value any of the predetermined number −1 of bits continuing from the predetermined number of continuous bits having the first logical value in the bit data.

### TECHNICAL FIELD

The present invention relates to a CAN communication system, a CAN transmission apparatus, a CAN reception apparatus, and a CAN communication method.

### BACKGROUND ART

A basic patent of a CAN (Controller Area Network) has been disclosed in Patent Literature 1. In this CAN protocol, transmission and reception of data between a transmission side and a reception side is synchronized by performing resynchronization during communication between the transmission side and the reception side. Hereinafter, a structure of the resynchronization in the CAN protocol will be specifically described.

FIG. 13 is a diagram showing change of a data length per 1 bit when jitter is generated in the CAN protocol. As shown in FIG. 13, data per 1 bit in a bit stream of the CAN protocol includes: a synchronization segment SYNC; a propagation time segment PROP; a phase buffer segment PHASE1; and a phase buffer segment PHASE2. There is a sample point that samples data between the phase buffer segment PHASE1 and the phase buffer segment PHASE2.

An upper diagram of FIG. 13 shows a data length per 1 bit that is recognized based on an ideal clock. Additionally, a lower diagram of FIG. 13 shows a data length per 1 bit that is recognized based on a clock delayed by jitter. Here, df shown in the lower diagram of FIG. 13 indicates a jitter ratio on the basis of an ideal clock length. As described above, when the reception side operates based on the clock delayed by jitter to recognize received data, the sample point is delayed as shown in the lower diagram of FIG. 13.

There is a problem that when such delay is accumulated, sampling cannot be performed at a timing when data should be essentially sampled as shown in FIG. 14. Specifically, as exemplified in FIG. 14, Low is sampled although High should be sampled as the 10th-bit data. However, in order to lower cost, it is desirable to use a low-cost clock oscillator, an SSCG (Spread Spectrum Clock Generator), etc., and to enable the reception side to operate even with a low-precision clock.

In order to solve such a problem, in the CAN protocol, when a falling edge has deviated from the synchronization segment SYNC at the time of receiving the falling edge of the bit stream, resynchronization to correct the sample point is performed only by a setting value of a jump width SJW. As a result of this, a clock error of the transmission side and the reception side can be absorbed. Specifically, as shown in FIG. 15, when the falling edge is detected early, a length of the setting value of the jump width SJW is subtracted from the phase buffer segment PHASE2, and thereby the error is adjusted to have synchronization so that the falling edge is located in the synchronization segment SYNC. In addition, conversely, when the falling edge is detected in a delayed manner, the length of the setting value of the jump width SJW is added to the phase buffer segment PHASE1, and thereby the error is adjusted to have synchronization so that the falling edge is located in the synchronization segment SYNC.

As described above, in the CAN protocol, resynchronization is performed according to detection of the falling edge as mentioned above. However, as for resynchronization according to the detection of the falling edge, the longer bits having the same logical value continue, the more decreases an opportunity of performing resynchronization, and thus the clock error is severely checked. Consequently, bit stuffing is incorporated in a technology disclosed in Patent Literature 1 as a structure of suppressing continuation of the same logical value.

Bit stuffing is a protocol in which after the same logical value continues over 5 bits on the bit stream, 1 bit having an inverted value of the logical value is inserted. As a result of this, continuation of the same logical value can be suppressed.

It is to be noted that a technology related to resynchronization has been disclosed in Patent Literature 2. A vehicular data transmission system pertaining to this technology detects a period when the same logic continues, and sets a resynchronization range of a data signal according to the detected period.

### CITATION LIST

### Patent Literature

Patent Literature 1: U.S. Pat. No. 5,001,642

Patent Literature 2: Japanese Unexamined Patent Application Publication No. H06-319172

### SUMMARY OF INVENTION

### Technical Problem

As mentioned above, in the structure of bit stuffing, after the same logical value continues over 5 bits on the bit stream, the stuff bit having the inverted value of the logical value is inserted. However, this means that a resynchronization interval is 10 bits at the longest. Specifically, this is because a width corresponds to a 10-bit width, the width continuing until a High stuff bit is inserted after continuous 5 bits of Low, a Low stuff bit is again inserted after continuous 5 bits of High, and then the falling edge is made.

However, as described above, the longer the resynchronization interval becomes, the larger an accumulated value of the clock error becomes, and thus high precision is required for a clock. That is, in order to perform system construction at low cost using the low-precision clock, it has become a problem that a worst value of the resynchronization interval is more shortened.

### Solution to Problem

A CAN communication system according to a first exemplary aspect of the present invention includes: a transmission apparatus in which when transmitting bit data having a plurality of continuous bits, each of the bits having either a first logical value or a second logical value that is an inversion of the first logical value, the transmission apparatus transmits transmission data instead of the bit data based on a CAN (Controller Area Network) protocol, the transmission data being data in which a stuff bit having an inverted value of the same logical value has been inserted next to the predetermined number of continuous bits having the same logical value in the bit data; a reception apparatus that executes synchronization processing to synchronize transmission and reception of the transmission data to and from the transmission apparatus according to detection of an edge from the second logical value to the first logical value in the transmission data transmitted from the transmission apparatus based on the CAN protocol. The transmission apparatus has a transmission control unit that rewrites to the first logical value any of the predetermined number −1 of bits continuing from the predetermined number of continuous bits having the first logical value in the bit data, when transmitting the bit data.

A CAN transmission apparatus according to a second exemplary aspect of the present invention is the transmission apparatus in which when transmitting bit data having a plurality of continuous bits, each of the bits having either a first logical value or a second logical value, to a reception apparatus that executes synchronization processing to synchronize transmission and reception of the data based on a CAN (Controller Area Network) protocol according to detection of an edge from the second logical value that is an inversion of the first logical value to the first logical value in reception data, the transmission apparatus transmits transmission data instead of the bit data based on the CAN protocol, the transmission data being data in which a stuff bit having an inverted value of the same logical value has been inserted next to the predetermined number of continuous bits having the same logical value in the bit data. The transmission apparatus has a control unit that rewrites to the first logical value any of the predetermined number −1 of bits continuing from a bit next to the predetermined number of continuous bits having the first logical value in the bit data, when transmitting the bit data.

A CAN reception apparatus according to a third exemplary aspect of the present invention is the reception apparatus in which when a transmission apparatus transmits bit data having a plurality of continuous bits, each of the bits having either a first logical value or a second logical value that is an inversion of the first logical value, the reception apparatus receives transmission data from the transmission apparatus instead of the bit data based on a CAN (Controller Area Network) protocol, the transmission data being data in which a stuff bit having an inverted value of the same logical value has been inserted next to the predetermined number of continuous bits having the same logical value in the bit data, and executes synchronization processing to synchronize transmission and reception of the transmission data to and from the transmission apparatus according to detection of an edge from the second logical value to the first logical value in the transmission data based on the CAN protocol. The edge from the second logical value to the first the logical value that the reception apparatus detects includes an edge from the second logical value to the first logical value to which the transmission apparatus has rewritten any of the predetermined number −1 of bits continuing from a bit next to the predetermined number of continuous bits having the first logical value in the bit data, when transmitting the bit data.

A CAN communication method according to a fourth exemplary aspect of the present invention between: a transmission apparatus in which when transmitting bit data having a plurality of continuous bits, each of the bits having either a first logical value or a second logical value that is an inversion of the first logical value, the transmission apparatus transmits transmission data instead of the bit data based on a CAN (Controller Area Network) protocol, the transmission data being data in which a stuff bit having an inverted value of the same logical value has been inserted next to the predetermined number of continuous bits having the same logical value in the bit data; and a reception apparatus that executes synchronous processing to synchronize transmission and reception of the transmission data to and from the transmission apparatus according to detection of an edge from the second logical value to the first logical value in the transmission data transmitted from the transmission apparatus based on the CAN protocol. When transmitting the bit data, the transmission apparatus rewrites to the first logical value any of the predetermined number −1 of bits continuing from a bit next to the predetermined number of continuous bits having the first logical value continue in the bit data.

According to the above-mentioned each aspect of the present invention, even though the second logical value continues from a stuff bit of the second logical value, an edge from the second logical value to the first logical value can be generated in a position before a position where a stuff bit having an inverted value of the second logical value is inserted. Therefore, the worst value of the resynchronization interval can be shortened.

### ADVANTAGEOUS EFFECTS OF INVENTION

According to the above-mentioned each aspect of the present invention, can be provided a CAN communication system, a CAN transmission apparatus, a CAN reception apparatus, and a CAN communication method that can construct the CAN communication system at low cost using a low-precision clock.

### BRIEF DESCRIPTION OF DRAWINGS

FIG. 1 is a configuration diagram of the CAN communication system pertaining to the embodiment 1 of the present invention.

FIG. 2 is a configuration diagram of the node pertaining to the embodiment 1 of the present invention.

FIG. 3 is a diagram of one example of a clock generated by a SSCG pertaining to the embodiment 1 of the present invention.

FIG. 4 is a diagram showing a structure of the extended stuff bit control unit pertaining to the embodiment 1 of the present invention.

FIG. 5 is a flow chart showing the transmission processing of the extended stuff bit control unit pertaining to the embodiment 1 of the present invention.

FIG. 6 is a flow chart showing the reception processing of the extended stuff bit control unit pertaining to the embodiment 1 of the present invention.

FIG. 7 is a diagram to describe a mechanism and effects pertaining to the embodiment 1 of the present invention.

FIG. 8 is a diagram showing a transmission frame data and a redundant data area pertaining to the embodiment 1 of the present invention.

FIG. 9 is a configuration diagram of a redundant data area pertaining to the embodiment 1 of the present invention.

FIG. 10 is a configuration diagram of the node pertaining to the embodiment 1 of the present invention.

FIG. 11 is a configuration diagram of the bit stream control unit pertaining to the embodiment 2 of the present invention.

FIG. 12 is a diagram to describe a mechanism and effects pertaining to the embodiment 2 of the present invention.

FIG. 13 is a diagram showing change of a data length per 1 bit when jitter is generated in the CAN protocol.

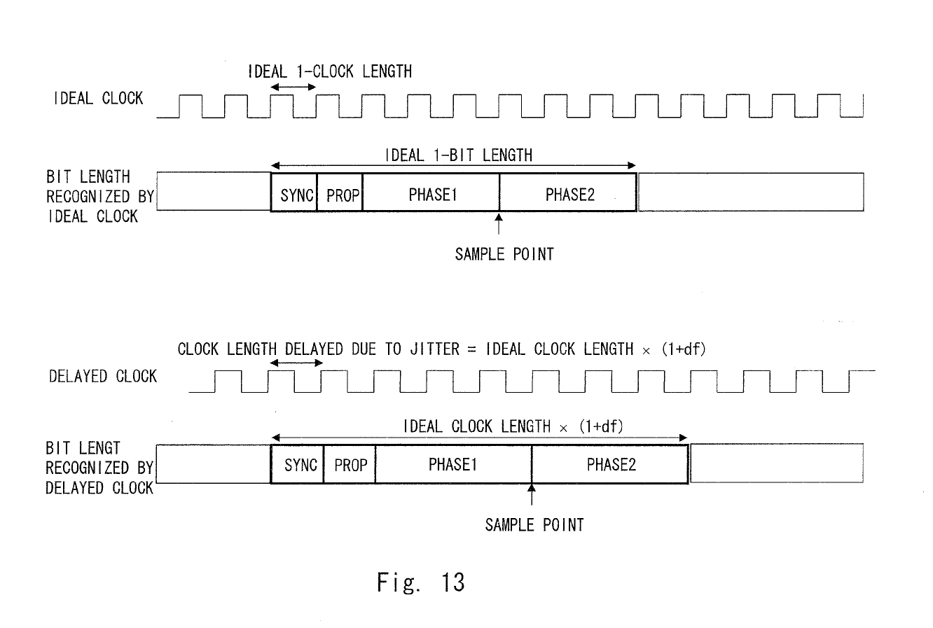

FIG. 14 is a diagram to describe a difference of a sample point.

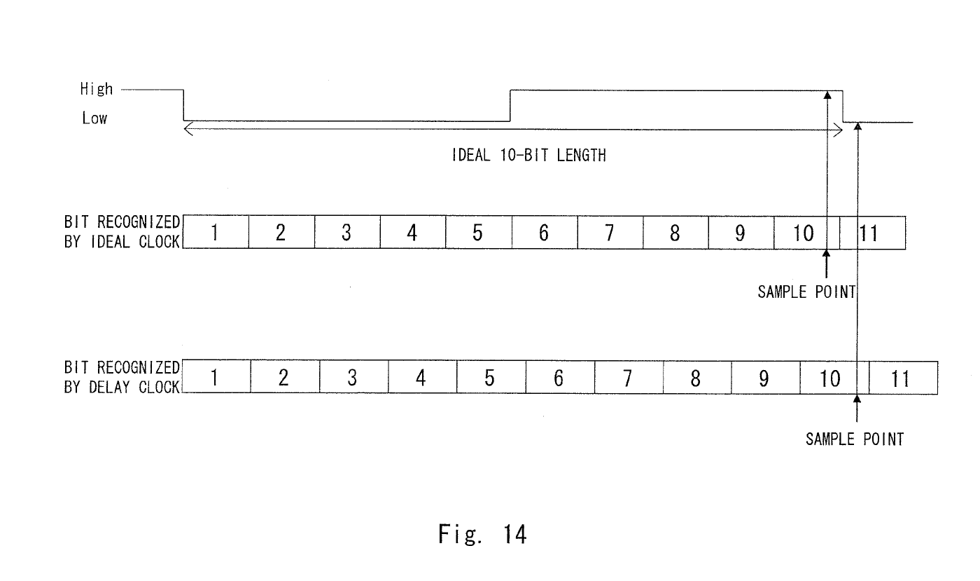

FIG. 15 is a diagram to describe a resynchronization in the CAN protocol.

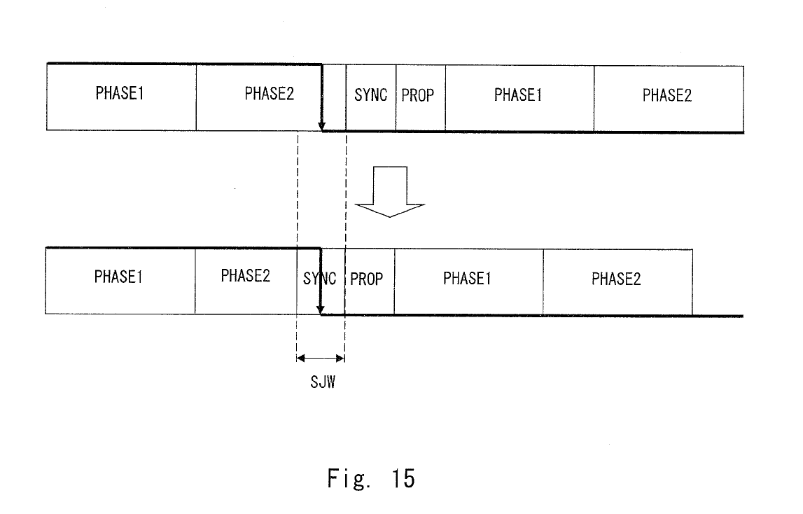

### DESCRIPTION OF EMBODIMENTS

### Embodiment 1 of the Invention

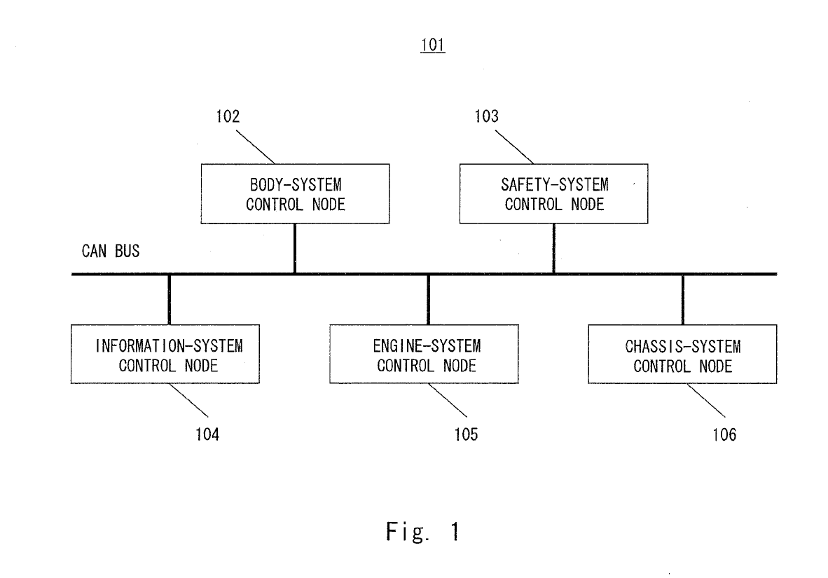

There will be described a configuration of a CAN communication system 101 pertaining to an embodiment 1 of the present invention with reference to FIG. 1. FIG. 1 is a configuration diagram of the CAN communication system 101 pertaining to the embodiment 1 of the present invention. In the embodiment, a case will be exemplified where the CAN communication system 101 is applied to an automobile.

The CAN communication system 101 has: a body-system control node 102; a safety-system control node 103; an information-system control node 104; an engine-system control node 105; and a chassis-system control node 106. The respective nodes 102 to 106 are mutually connected by a CAN bus, and can mutually transmit and receive arbitrary data.

The body-system control node 102 controls body-system devices, such as a head lamp, an air conditioner, and a door, based on data received from the other nodes. The safety-system control node 103 controls safety-system devices, such as a sensor and an air bag, based on data received from the other nodes. The information-system control node 104 controls information-system devices, such as a car audio, a car radio, and a car television, based on data received from the other nodes. The engine-system control node 105 controls engine-system devices, such as an engine and an AT (Automatic Transmission), based on data received from the other nodes. The chassis-system control node 106 controls chassis-system devices, such as a steering and a brake, based on data received from the other nodes. In addition, each of the respective nodes 102 to 106 transmits data based on a control result to the other nodes if needed.

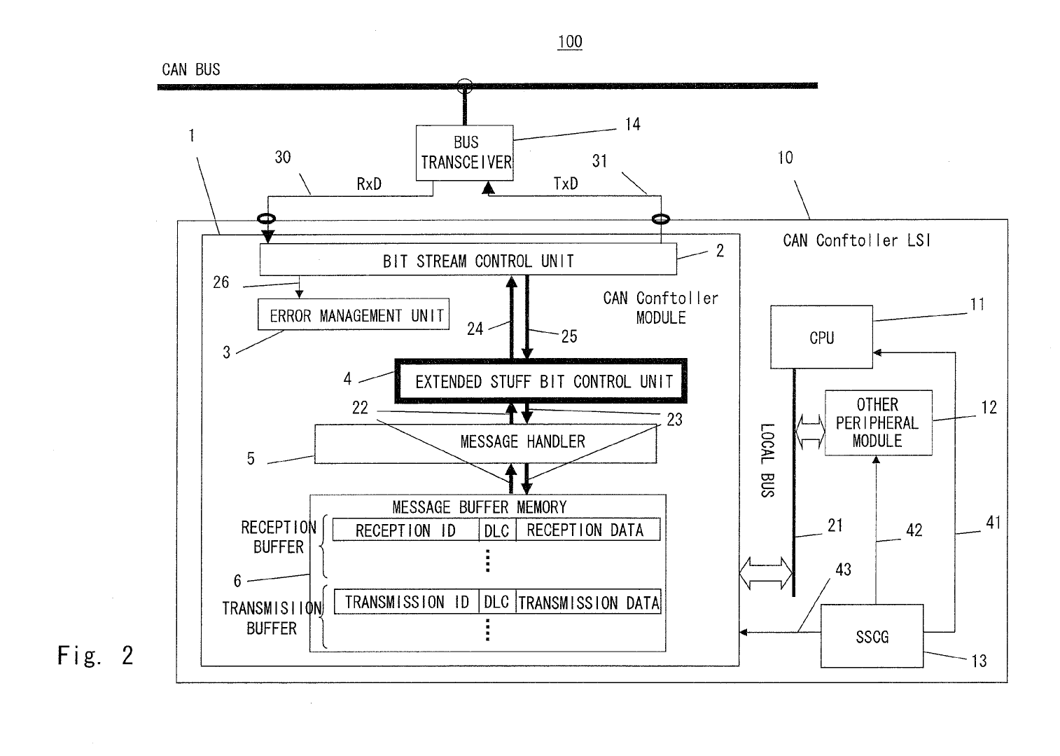

Subsequently, there will be described a configuration of a node 100 pertaining to the embodiment 1 of the present invention with reference to FIG. 2. FIG. 2 is a configuration diagram of the node 100 pertaining to the embodiment 1 of the present invention. In the embodiment 1, the respective nodes 102 to 106 shall have configurations similar to the node 100.

The node 100 has a CAN controller LSI (Large Scale Integration) 10 and a bus transceiver 14. The CAN controller LSI 10 has: a CAN controller module 1; a CPU (Central Processing Unit) 11; an other peripheral module 12; and an SSCG (Spread Spectrum Clock Generator) 13. The CAN controller module 1 has: a bit stream control unit 2; an error management unit 3; an extended stuff bit control unit 4; a message handler 5; and a message buffer memory 6. The CAN controller module 1, the CPU 11, and the other peripheral module 12 are mutually connected by a local bus 21, and can mutually transmit and receive arbitrary data.

The CAN controller module 1 is accessed from the CPU 11 through the local bus 21. The CAN controller module 1 is connected to the CAN bus through the bus transceiver 14. The CAN controller module 1 transmits and receives data to and from the other nodes according to a request from the CPU 11.

The bit stream control unit 2 calculates a CRC (Cyclic Redundancy Check) based on transmission frame data 24 output from the extended stuff bit control unit 4. The bit stream control unit 2 adds the CRC to the transmission frame data 24 in accordance with a frame format of a CAN protocol. The bit stream control unit 2 inserts a stuff bit in the transmission frame data to which the CRC has been added based on bit stuffing defined by the CAN protocol. That is, next to continuous 5 bits having the same logical value, the stuff bit having an inverted logical value of the logical value is inserted. The bit stream control unit 2 outputs to the bus transceiver 14 the transmission frame data in which the stuff bit has been inserted as a transmission data output (TxD) 31.

In addition, the bit stream control unit 2 removes the stuff bit defined by the CAN protocol from a reception data input (RxD) 30 output from the bus transceiver 14. The bit stream control unit 2 performs CRC check based on the reception frame data in which the stuff bit has been removed from the reception data input (RxD) 30. When detecting an abnormality by the CRC check, the bit stream control unit 2 outputs to the error management unit 3 an abnormality notification signal 26 that notifies of the abnormality. The bit stream control unit 2 removes the CRC from the reception frame data after the CRC check. The bit stream control unit 2 outputs to the extended stuff bit control unit 4 reception frame data 25 from which the CRC has been removed.

In addition, the bit stream control unit 2 performs resynchronization defined by the CAN protocol. That is, when detecting a falling edge in the reception data input (RxD) 30, the bit stream control unit 2 adjusts a sample point by changing a length of a phase buffer segment PHASE1 or a length of a phase buffer segment PHASE2 by a setting value of a jump width SJW so that the falling edge is located in a synchronization segment SYNC.

The error management unit 3 performs processing according to an output of the abnormality notification signal 26 from the bit stream control unit 2. This processing is, for example, set as processing in which the error management unit 3 further notifies the CPU 11 of abnormality, and thereby the CPU 11 may perform processing to recover from the abnormality or control of the other peripheral module 12 to recover from the abnormality according to the notice.

The extended stuff bit control unit 4 overwrites an extended stuff bit with respect to transmission frame data 22 output from the message handler 5 based on a scheme that will be mentioned later. At this time, the extended stuff bit control unit 4 records a primary logical value before overwriting the extended stuff bit on a redundant data area of the transmission frame data 24, and outputs to the bit stream control unit 2 the transmission frame data 24 in which the extended stuff bit has been overwritten.

In addition, the extended stuff bit control unit 4 corrects the extended stuff bit to the primary logical value by the primary logical value recorded on the redundant data area based on the scheme that will be mentioned later with respect to the reception frame data 25 output from the bit stream control unit 2. The extended stuff bit control unit 4 outputs to the message handler 5 reception frame data 23 in which the extended stuff bit is corrected to the primary logical value.

The message handler 5 obtains the transmission frame data 22 stored in a transmission buffer of the message buffer memory 6, and transfers it to the extended stuff bit control unit 4. In addition, the message handler 5 stores the reception frame data 23 output from the extended stuff bit control unit 4 in a reception buffer of the message buffer memory 6.

The message buffer memory 6 has the reception buffer and the transmission buffer. Transmission frame data that is transmitted to an other node is stored in the transmission buffer. Transmission frame data that has received from an other node is stored in the reception buffer. The message buffer memory 6 has a storage device for configuring the reception buffer and the transmission buffer. The storage device is, for example, a register, a memory, etc.

The CAN controller LSI 10 controls the devices included in the node 100. For example, when the node 100 is the engine-system control node 105, the CAN controller LSI 10 controls engine-system devices.

The CPU 11 controls the devices included in the node 100 by outputting control instruction data to instruct control of the devices included in the node 100 to the other peripheral module through the local bus 21. The CPU 11 decides control contents for the devices included in the node 100, for example, based on the data received from the other node. The CPU 11 obtains data transmitted from the other node from the reception buffer of the message buffer memory 6 through the local bus 21. The CPU 11 stores data that is transmitted to the other node in the transmission buffer of the message buffer memory 6 through the local bus 21.

The other peripheral module 12 controls the devices included in the node 100 based on the control instruction data output from the CPU 11.

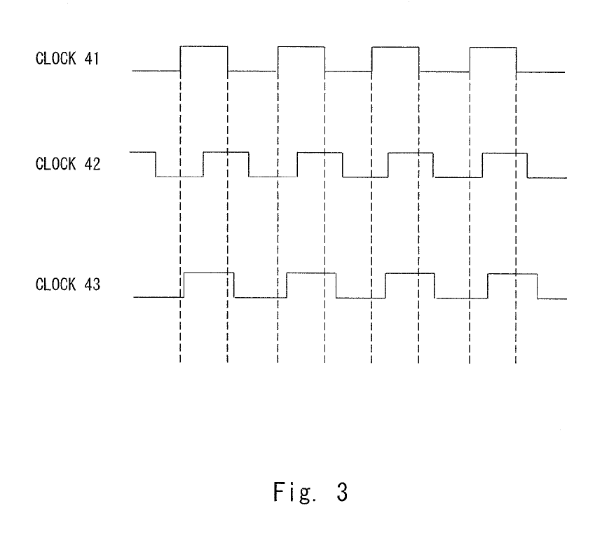

The SSCG 13 supplies each of the clocks 41 to 43 to each of the circuits, such as the CAN controller module 1, the CPU 11, and the other peripheral module 12 in the CAN controller LSI 10. That is, the embodiment 1 exemplifies a case where the SSCG 13 is the multi-output SSCG. The SSCG 13, as exemplified in FIG. 3, adds jitter to clocks in order to reduce noise in the clocks. In FIG. 3, a case is exemplified where a clock 41 is an ideal clock, and clocks 42 and 43 are delayed by the jitter. As described above, although the SSCG 13 has low EMI (Electro Magnetic Interference), precision of the clocks becomes low.

The bus transceiver 14 transmits to the other node the transmission data output 31 output from the bit stream control unit 2 as a bit stream. The bus transceiver 14 outputs to the bit stream control unit 2 a bit stream received from the other node as the reception data input 30.

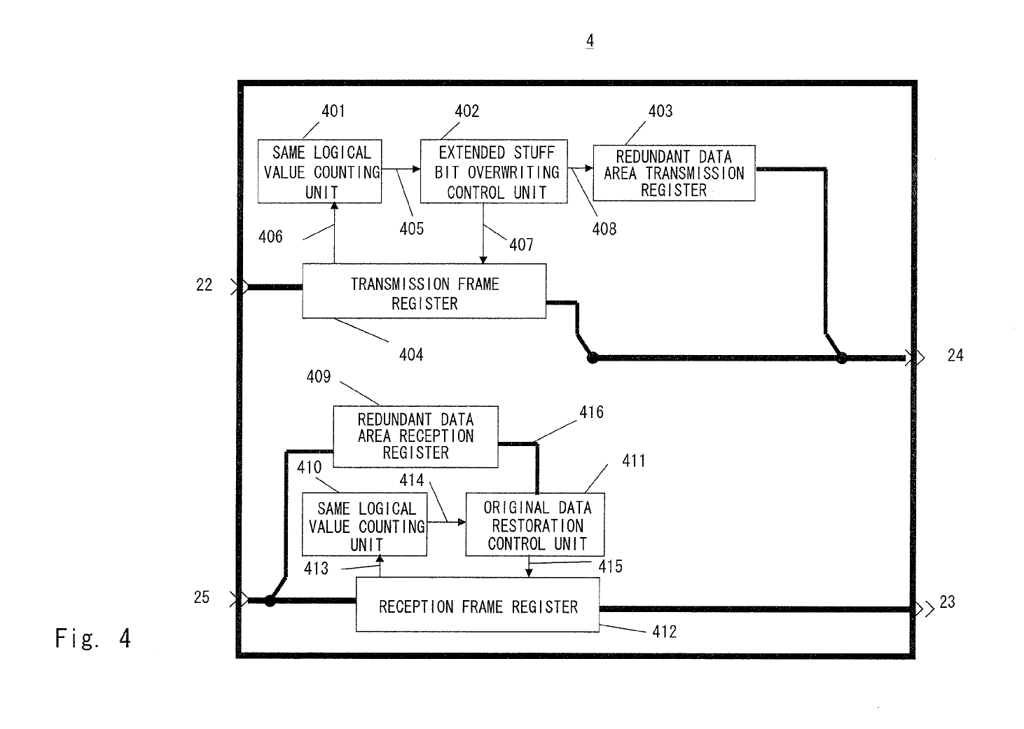

Subsequently, there will be described a configuration of the extended stuff bit control unit 4 pertaining to the embodiment 1 of the present invention with reference to FIG. 4. FIG. 4 is a configuration diagram of the extended stuff bit control unit 4 pertaining to the embodiment 1 of the present invention.

The extended stuff bit control unit 4 has: the same logical value counting unit 401; an extended stuff bit overwriting control unit 402; a redundant data area transmission register 403; a transmission frame register 404; a redundant data area reception register 409; the same logical value counting unit 410; an original data restoration control unit 411; and a reception frame register 412.

The same logical value counting unit 401 counts the number of continuous bits having the same logical value in a transmission frame bit read value 406 that is the value read 1 bit by 1 bit in order from a head of the transmission frame data 22 stored in the transmission frame register 404. When detecting continuous 5 bits having the same logical value, the same logical value counting unit 401 outputs a continuous 5 bits having same logical value detection signal 405 to the extended stuff bit overwriting control unit 402.

The extended stuff bit overwriting control unit 402 reads a logical value of a bit next to the continuous 5 bits having the same logical value of the transmission frame data 22 stored in the transmission frame register 404 according to an output of the continuous 5 bits having same logical value detection signal 405 from the same logical value counting unit 401, and writes it in a corresponding bit of the redundant data area transmission register 403. The extended stuff bit overwriting control unit 402 then overwrites a bit next to the continuous 5 bits having the same logical value with the same logical value continuing over 5 bits. That is, the logical value before being overwritten is stored in the redundant data area transmission register 403. In addition, the overwritten bit serves as an extended stuff bit. The same logical value counting unit 401 and the extended stuff bit overwriting control unit 402 perform this processing to the whole transmission frame data 22 stored in the transmission frame register 404. Consequently, the logical value before being overwritten of the extended stuff bit is stored in the redundant data area transmission register 403 only by the number of extended stuff bits in the transmission frame data 22.

The extended stuff bit control unit 4 outputs to the bit stream control unit 2 as the transmission frame data 24 data obtained by coupling transmission frame data overwritten with the extended stuff bit stored in the transmission frame register 404, and the logical value before being overwritten of the extended stuff bit stored in the redundant data area transmission register 403, after end of the processing to the whole transmission frame data 22. Here, a portion corresponding to the logical value before being overwritten in the transmission frame data 24 is called a redundant data area.

The logical value before being overwritten of the extended stuff bit is stored in the redundant data area transmission register 403. A logical value before being overwritten corresponding to each of the extended stuff bits included in the transmission frame data 22 is stored in the redundant data area transmission register 403.

The transmission frame data 22 output from the message handler 5 is stored in a transmission frame register 407.

Data in the redundant data area of the reception frame data 25 output from the bit stream control unit 2 is stored in the redundant data area reception register 409. That is, a logical value before being overwritten corresponding to each of the extended stuff bits included in the reception frame data 25 is stored in the redundant data area reception register 409.

The same logical value counting unit 410 counts the number of continuous same logical values in a reception frame bit read value 413 that is a value read 1 bit by 1 bit in order from a head of the data stored in the reception frame register 412. When detecting continuous 5 bits having the same logical value, the same logical value counting unit 410 outputs a continuous 5 bits having same logical value detection signal 414 to the original data restoration control unit 411.

The original data restoration control unit 411 obtains a logical value 415 before being overwritten of an extended stuff bit next to continuous 5 bits having the same logical value among the logical values of the redundant data area having output from the redundant data area reception register 409 according to the continuous 5 bits having same logical value detection signal 414 from the same logical value counting unit 410. The original data restoration control unit 411 then overwrites an extended stuff bit of the reception frame register 412 with the obtained logical value 415. As a result of this, the logical value of the extended stuff bit is restored to the primary logical value. The same logical value counting unit 410 and the original data restoration control unit 411 perform this processing to the whole data stored in the reception frame register 412. As a result of this, all the extended stuff bits included in the data stored in the reception frame register 412 are restored to primary logical values. The extended stuff bit control unit 4 outputs data after being restored stored in the reception frame register 412 to the message handler 5 as the reception frame data 23 after the end of the processing to the whole data stored in the reception frame register 412.

In the reception frame register 412, stored is data of a portion corresponding to the primary reception frame data 23 excluding the redundant data area of the reception frame data 25 output from the bit stream control unit 2.

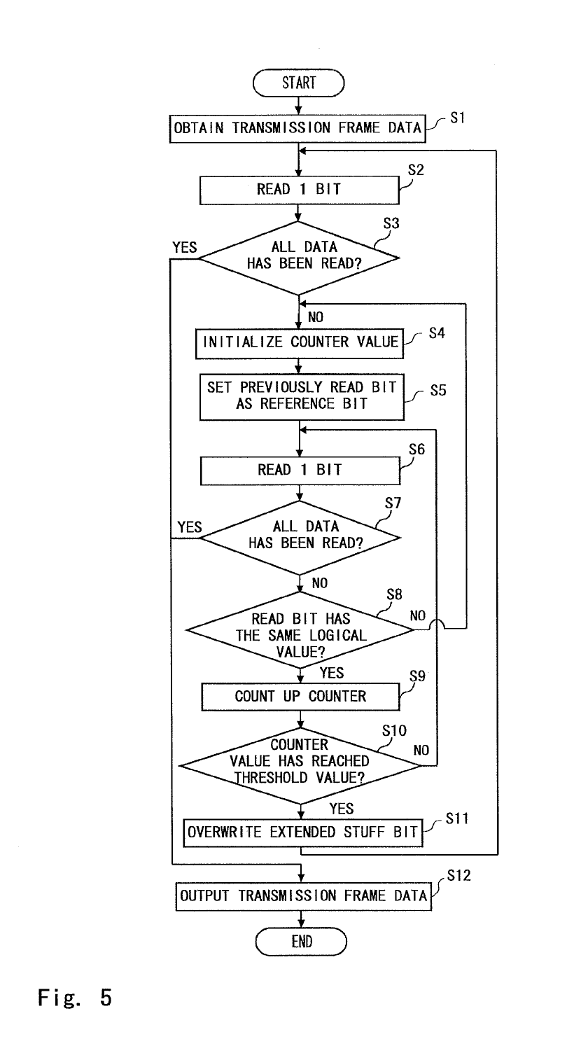

Subsequently, there will be described transmission processing of the extended stuff bit control unit 4 pertaining to the embodiment 1 of the present invention with reference to FIG. 5. FIG. 5 is a flow chart showing the transmission processing of the extended stuff bit control unit 4 pertaining to the embodiment 1 of the present invention.

The extended stuff bit control unit 4 obtains the transmission frame data 22 from the transmission buffer of the message buffer memory 6 through the message handler 5, and stores it in the transmission frame register 404 (S1).

The same logical value counting unit 401 reads 1 bit from the transmission frame data 22 stored in the transmission frame register 404 (S2). It is to be noted that reading of 1 bit in this step S2 and step S6 that will be mentioned later is performed in order from a head of the transmission frame data 22. Consequently, 1 bit of the head of the transmission frame data 22 is read at first reading, and when reading of bits has already been performed, a bit next to a previously read bit is read. Here, order from the head of the transmission frame data 22 is equal to order of transmitting bits included in the transmission frame data 22. The same logical value counting unit 401 determines whether or not all the transmission frame data 22 stored in the transmission frame register 404 has been read (S3).

When the same logical value counting unit 401 determines that all the transmission frame data 22 has been read (S3: Yes), the extended stuff bit control unit 4 executes processing of step S12 that will be mentioned later.

When determining that not all the transmission frame data 22 has been read (S3: No), the same logical value counting unit 401 initializes a count value of a counter to “1” (S4). The same logical value counting unit 401 sets a previously read bit as a reference bit serving as a reference to count whether or not the same logical value continues over 5 bits (S5). The same logical value counting unit 401 reads 1 bit from the transmission frame data 22 stored in the transmission frame register 404 (S6). The same logical value counting unit 401 determines whether or not all the transmission frame data 22 stored in the transmission frame register 404 has been read (S7).

When the same logical value counting unit 401 has read all the transmission frame data 22 (S7: Yes), the extended stuff bit control unit 4 executes processing of step S12 that will be mentioned later.

When not having read all the transmission frame data 22 (S7: No), the same logical value counting unit 401 determines whether or not the reference bit and the previously read bit have the same logical value (S8).

When the read bit does not have the same logical value (S8: No), the same logical value counting unit 401 restarts processing from step S4. In this case, the same logical value does not continue. Therefore, the same logical value counting unit 401 returns to step S4, and restarts counting of whether or not the same logical value continues over 5 bits using the previously read bit as the reference bit.

When the read bit has the same logical value (S8: No), the same logical value counting unit 401 counts up the counter (S9). The same logical value counting unit 401 determines whether or not the counter value reaches a threshold value “5” (S10).

When the counter value does not reach the threshold value “5” (S10: No), the same logical value counting unit 401 restarts processing from step S6. In this case, although the same logical value continues from the reference bit to the previously read bit, the same logical value has not continued over 5 bits yet. Therefore, the same logical value counting unit 401 returns to step S6, and confirms a logical value of a next bit.

When the counter value reaches the threshold value “5” (S10: Yes), the same logical value continues over 5 bits from the reference bit to the previously read bit. That is, a stuff bit is inserted between the previously read bit and the bit next thereto. Therefore, the extended stuff bit overwriting control unit 402 reads a logical value of an extended stuff bit next to the previously read bit, and writes it in a bit corresponding to the extended stuff bit of the redundant data area transmission registers 403. The extended stuff bit overwriting control unit 402 then overwrites the extended stuff bit with the logical value continuing over 5 bits (S11). In a manner described above, since the logical values of the stuff bit and the extended stuff bit differ when the stuff bit is inserted, an edge is generated between the stuff bit and the extended stuff bit. The same logical value counting unit 401 then returns to step S2, reads a next extended stuff bit (S2) to set as a reference bit (S5), and restarts counting of whether or not the same logical value continues over 5 bits.

In step S12, the extended stuff bit control unit 4 generates the transmission frame data 24 based on the data stored in the transmission frame register 404 and the data stored in the redundant data area transmission register 403, and outputs it to the bit stream control unit 2 (S12).

Although the transmission processing of the extended stuff bit control unit 4 pertaining to the embodiment 1 of the present invention has been described in the above, it is not limited to the above-mentioned procedure as long as it is the processing to overwrite an extended stuff bit next to continuous 5 bits having the same logical value, and may be changed appropriately. For example, although the reference bit is set, and the logical value of the reference bit and the logical value of the previously read bit are compared with each other, the logical value of the previously read bit and a logical value of a bit read previously to the bit may be compared with each other. In addition, for example, an execution sequence of processing of steps S4 and S5 may be reversed.

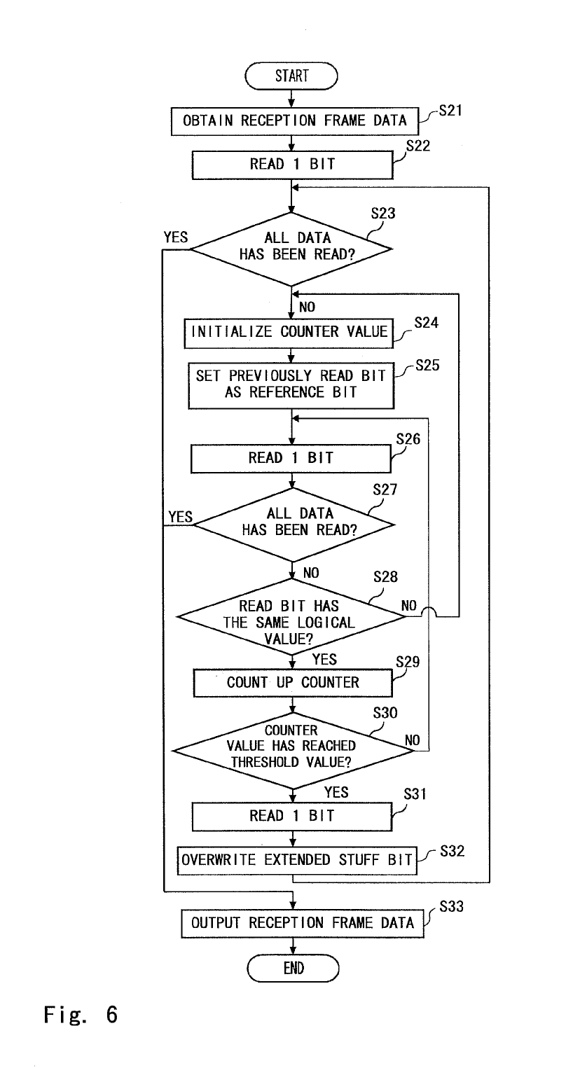

Subsequently, there will be described reception processing of the extended stuff bit control unit 4 pertaining to the embodiment 1 of the present invention with reference to FIG. 6. FIG. 6 is a flow chart showing the reception processing of the extended stuff bit control unit 4 pertaining to the embodiment 1 of the present invention.

The extended stuff bit control unit 4 obtains the reception frame data 25 output from the bit stream control unit 2, stores data in the redundant data area of the obtained reception frame data 25 in the redundant data area reception register 409, and stores the other data in the reception frame register 412 (S21).

The same logical value counting unit 410 reads 1 bit from the reception frame data 25 stored in the reception frame register 412 (S22). It is to be noted that reading of 1 bit in this step S22 and steps S26 and S31 that will be mentioned later is performed in order from a head of the reception frame data 25. Consequently, 1 bit of the head of the reception frame data 25 is read at first reading, and when reading of bits has already been performed, a bit next to a previously read bit is read. Here, order from the head of the reception frame data 25 is equal to order of receiving bits included in the reception frame data 25. The same logical value counting unit 410 determines whether or not all data stored in the reception frame register 412 has been read (S23).

When the same logical value counting unit 410 determines that all the data stored in the reception frame register 412 has been read (S23: Yes), the extended stuff bit control unit 4 executes processing of step S33 that will be mentioned later.

When determining that not all the data stored in the reception frame register 412 has not been read (S23: No), the same logical value counting unit 410 initializes a count value of a counter to “1” (S24). The same logical value counting unit 410 sets a previously read bit as a reference bit serving as a reference to count whether or not the same logical value continues over 5 bits (S25). The same logical value counting unit 410 reads 1 bit from the data stored in the reception frame register 412 (S26). The same logical value counting unit 410 determines whether or not all the data stored in the reception frame register 412 has been read (S27).

When the same logical value counting unit 410 has read all the data stored in the reception frame register 412 (S27: Yes), the extended stuff bit control unit 4 executes processing of step S33 that will be mentioned later.

When not having read all the data stored in the reception frame register 412 (S27: No), the same logical value counting unit 410 determines whether or not the reference bit and the previously read bit have the same logical value (S28).

When the read bit does not have the same logical value (S28: No), the same logical value counting unit 410 restarts processing from step S24. In this case, the same logical value does not continue. Therefore, the same logical value counting unit 410 returns to step S24, and restarts counting of whether or not the same logical value continues over 5 bits using the previously read bit as the reference bit.

When the read bit has the same logical value (S28: Yes), the same logical value counting unit 410 counts up the counter (S29). The same logical value counting unit 410 determines whether or not the counter value reaches a threshold value “5” (S30).

When the counter value does not reach the threshold value “5” (S30: No), the same logical value counting unit 410 restarts processing from step S26. In this case, although the same logical value continues from the reference bit to the previously read bit, the same logical value has not continued over 5 bits yet. Therefore, the same logical value counting unit 410 returns to step S26, and confirms a logical value of a next bit.

When the counter value reaches the threshold value “5” (S30: Yes), the same logical value continues over 5 bits from the reference bit to the previously read bit. That is, a bit next to the previously read bit serves as an extended stuff bit. At this time, the same logical value counting unit 410 reads 1 bit of a next extended stuff bit from the reception frame data 25 stored in the reception frame register 412, before the extended stuff bit is restored to a logical value before being overwritten (S31). The original data restoration control unit 411 reads a logical value before being overwritten stored in a bit corresponding to the extended stuff bit of the redundant data area reception register 409. The original data restoration control unit 411 then overwrites the extended stuff bit of the reception frame register 412 with the read logical value before being overwritten (S32). As a result of this, the extended stuff bit is restored to the logical value before being overwritten. The same logical value counting unit 401 then returns to step S23, sets the previously read bit as the reference bit (S25), and restarts counting of whether or not the same logical value continues over 5 bits.

In step S33, the extended stuff bit control unit 4 outputs to the message handler 5 the reception frame data 23 generated by returning the extended stuff bit of the reception frame data 25 stored in the reception frame register 412 to the logical value before being overwritten (S33).

Although the reception processing of the extended stuff bit control unit 4 pertaining to the embodiment 1 of the present invention has been described in the above, it is not limited to the above-mentioned procedure as long as it is the processing to restore the logical value before being overwritten to an extended stuff bit next to continuous 5 bits having the same logical value, and may be changed appropriately. For example, although the reference bit is set, and the logical value of the reference bit and the logical value of the read bit are compared with each other, the logical value of the previously read bit and a logical value of a bit read previously to the bit may be compared with each other. In addition, for example, an execution sequence of processing of steps S24 and S25 may be reversed.

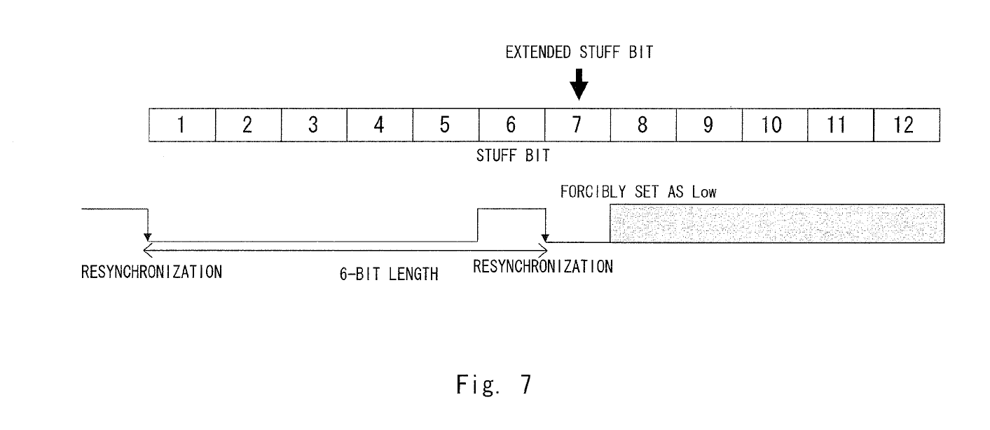

Subsequently, a mechanism and effects of the embodiment 1 will be described with reference to FIG. 7. Here, a case will be described where Low continues over 5 bits as the same logical value.

According to the above-mentioned embodiment 1, when Low continues over 5 bits as the same logical value, Low of the same logical value is forcibly set for a bit next to the 5 bits. In a manner described above, when after that, a stuff bit of High is inserted next to continuous 5 bits having Low in the transmission frame data, a bit next to the stuff bit can be set as Low. That is, an extended stuff bit immediately after the stuff bit is overwritten with Low, and thereby a falling edge that is a resynchronization edge defined by the CAN protocol is produced.

According to the above, a worst value of a resynchronization interval can be shortened from 10 bits to six bits. Consequently, as exemplified with reference to FIG. 3, even if a system is constructed by an SSCG, a clock oscillator, etc. that generate a low-precision clock, an effect of the low-precision clock can be reduced. That is, even if the SSCG and the clock oscillator that are low in cost but generate the low-precision clock are used, it becomes possible to construct a CAN communication system. Therefore, according to the embodiment 1, the CAN communication system can be constructed at low cost using the low-precision clock.

Here, there has been a problem that although the SSCG that generates a clock to which jitter has been purposely added is effective for decreasing EMI noise, it cannot be easily used since a clock error among nodes becomes large. In contrast with that, since the SSCG can be used as mentioned above in the embodiment 1, noise can be reduced. For example, since in a case of an in-vehicle application, a frequency band of an FM (Frequency Modulation) radio overlaps with an operating frequency of a general MCU (Micro Control Unit), noise mixed in the frequency band can be reduced to enhance sound quality. In addition, along with speeding-up of the operating frequency, it is considered that harmonic noise has harmful effects also on a UHF (Ultra High Frequency) band. In contrast with that, since the noise can be reduced by the SSCG in the embodiment 1, Full-Seg TV reception in a car navigation can be stabilized.

It is to be noted that although in the above-mentioned embodiment 1, in the transmission frame data 22, the bit next to continuous 5 bits having the same logical value is set as the extended stuff bit, the extended stuff bit is overwritten with the same logical value continuing over 5 bits, and thereby the edge is generated, the present invention is not limited to this. In other words, although a bit in which the stuff bit is inserted immediately before the bit is set as the extended stuff bit, the extended stuff bit is overwritten with the inverted value of the logical value of the stuff bit, and thereby the edge is generated, the present invention is not limited to this. For example, any one of 4 bits continuing from a bit next to continuous 5 bits having the same logical value (=the number of bits “5” in which a stuff bit is inserted when the same logical value continues−the number of stuff bits “1”) is set as an extended stuff bit, and the extended stuff bit may be overwritten with the same logical value continuing over 5 bits. Even in a manner described above, the worst value of the resynchronization interval can be shortened from 10 bits.

Describing specifically with an example, when the logical value of High continues from the sixth bit of stuff bit in FIG. 7, the worst value of the resynchronization interval can be shortened from 10 bits to 9 bits even if the 10 th bit of bit is overwritten with Low. That is, even if in the transmission frame data 22, any one of 4 bits (a seventh bit to a 10 th bit of FIG. 7) continuing from the extended stuff bit next to continuous 5 bits (a first bit to a fifth bit of FIG. 7) having the same logical value is overwritten with the same logical value continuing over 5 bits, the worst value of the resynchronization interval can be shortened.

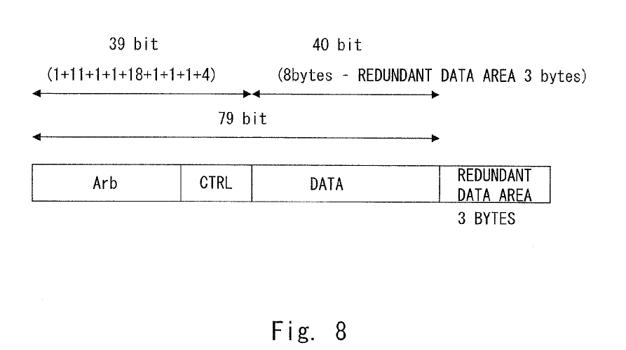

In addition, what a primary logical value of the overwritten stuff bit is is indicated by the redundant data areas of the transmission frame data 24 and the reception frame data 25. For example, as shown in FIG. 8, 3 bytes of redundant data area is defined with respect to the transmission frame data 22 having a size up to 79 bits. Here, the transmission frame data 22 includes a start of frame, an arbitration field Arb, a control field CTRL, and a data field DATA in a data frame of the CAN protocol.

As shown in FIG. 8, in the data frame of the CAN protocol, 3 bytes of region of up to 8 bytes of region normally used as the data field DATA is used as the redundant data area. Therefore, the transmission frame data 22 is the data up to 79 bits including: a 1-bit start of frame; up to 32 (=11+1+1+18+1) bits of arbitration field Arb; 6 (=1+1+4) bits of control field CTRL; and up to 40 bits (=8 bytes−3 bytes) of data field DATA.

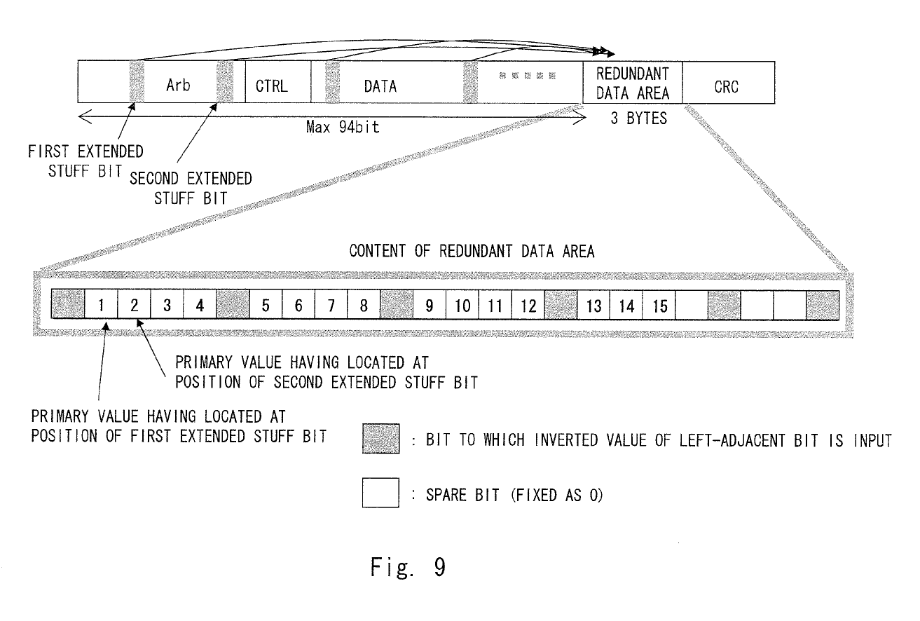

Subsequently, a configuration of the redundant data area will be described with reference to FIG. 9. A logical value before being overwritten is stored in the redundant data area so as to correspond to each of the extended stuff bits of the transmission frame data. Here, since one stuff bit is inserted whenever the same logical value continues over 5 bits, up to 15 bits of stuff bit is inserted in the 79 bits of transmission frame data 22. Consequently, a size of the transmission frame data after insertion of the stuff bit from the head to the front of the redundant data area is up to 94 (=79+15) bits as shown in FIG. 9. In addition, since the number of extended stuff bits is equal to the number of stuff bits, up to 15 bits of extended stuff bit is set. Therefore, as shown in FIG. 9, up to 15 bits of logical value before being overwritten of the extended stuff bit is recorded in the redundant data area. It is to be noted that although in FIG. 9, a logical value before being overwritten of each of the extended stuff bits in order from the head toward an end of the transmission frame data is stored in each of the bits in order from the head toward an end of the redundant data area, the present invention is not limited to this as long as the extended stuff bit and the logical value before being overwritten correspond to each other. It is to be noted that the order from the head toward the end means transmission order in a case where the transmission frame data is transmitted as a bit stream.

Furthermore, as shown in FIG. 9, a bit having as a logical value an inverted value of a left-adjacent bit is provided for each 4 bits inside the redundant data area. That is, the bit having the inverted value of the previous bit is provided for each 4 bits in the redundant data area. According to the above, the same logical value is prevented from continuing over 5 bits in the redundant data area, and the stuff bit can be prevented from being inserted in the redundant data area. This is because when the extended stuff bit needs to be provided in the redundant data area, a redundant data area corresponding to the extended stuff bit is further needed. In addition, according to the above, the resynchronization interval can also be shortened.

As described above, in the embodiment 1, the redundant data area is defined to be a 3-byte length as a size that can include up to 15 bits of bit having the logical value before being overwritten, and the bit having as the logical value the inverted value of the previous bit for each 4 bits. It is to be noted that the size of the redundant data area is not limited to the size exemplified here, as long as it is the size in which all of the extended stuff bits can be recorded even when the number of extended stuff bits increases the most, based on a maximum size of the transmission frame data 22.

### Embodiment 2 of the Invention

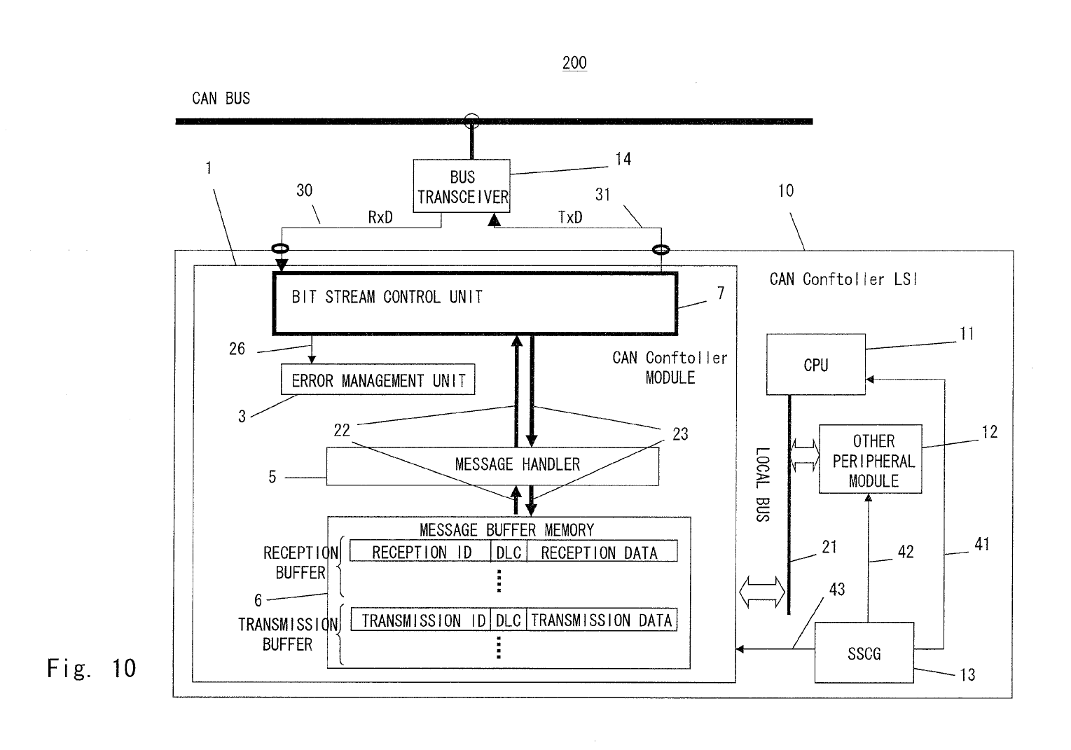

Subsequently, there will be described a configuration of a node 200 pertaining to an embodiment 2 of the present invention with reference to FIG. 10. FIG. 10 is a configuration diagram of the node 200 pertaining to the embodiment 2 of the present invention. It is to be noted that description of contents similar to the node 100 pertaining to the embodiment 1 is omitted. In addition, since a configuration of a CAN communication system pertaining to the embodiment 2 of the present invention is similar to that of the embodiment 1, description thereof is omitted.

The node 200 differs from the node 100 pertaining to the embodiment 1 in a point where it does not have the extended stuff bit control unit 4, but has a bit stream control unit 7 instead of the bit stream control unit 2.

The bit stream control unit 7 further performs resynchronization also in a rising edge in addition to the processing in the bit stream control unit 2 pertaining to the embodiment 1. That is, the bit stream control unit 7 performs resynchronization also in the rising edge in addition to the resynchronization in the falling edge defined by the CAN protocol. In addition, the message handler 5 transmits and receives the transmission frame data 22 and the reception frame data to and from the bit stream control unit 7 and the message buffer memory 6.

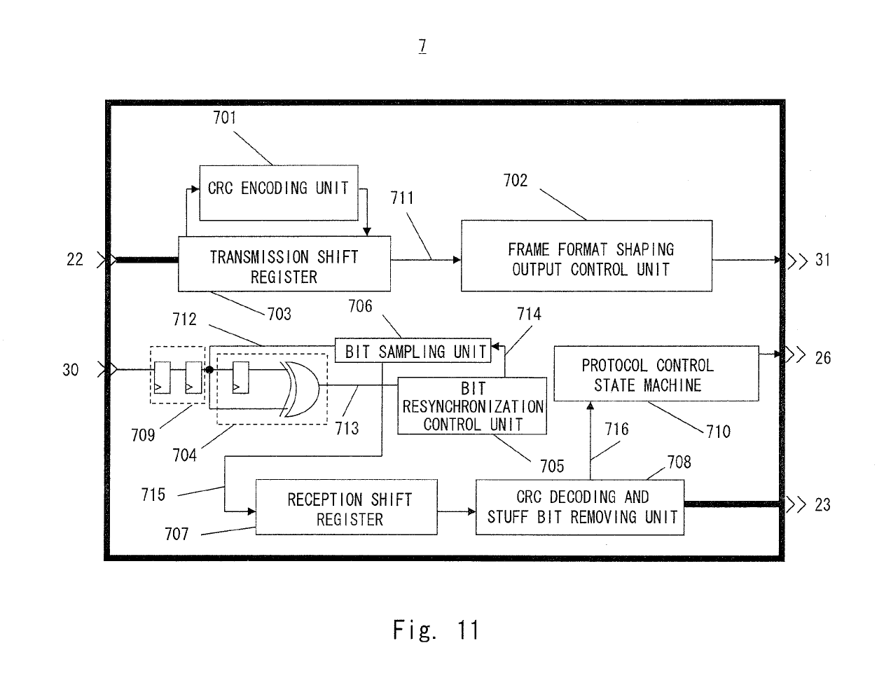

Subsequently, there will be described a configuration of the bit stream control unit 7 pertaining to the embodiment 2 of the present invention with reference to FIG. 11. FIG. 11 is a configuration diagram of the bit stream control unit 7 pertaining to the embodiment 2 of the present invention.

The bit stream control unit 7 has: a CRC encoding unit 701; a frame format shaping output control unit 702; a transmission shift register 703; a both rising and falling edge detection circuit 704; a bit resynchronization control unit 705; a bit sampling unit 706; a reception shift register 707; a CRC decoding and stuff bit removing unit 708; a flip-flop group 709; and a protocol control state machine 710.

The CRC encoding unit 701 generates a CRC based on the transmission frame data 22 output from the transmission shift register 703. The CRC encoding unit 701 outputs the generated CRC to the transmission shift register 703.

The frame format shaping output control unit 702 inserts a stuff bit in data 711 output from the transmission shift register 703, and outputs it to the bus transceiver 14 as the transmission data output (TXD) 31.

The transmission shift register 703 outputs the transmission frame data 22 output from the message handler 5 sequentially 1 bit by 1 bit to the CRC encoding unit 701 and the frame format shaping output control unit 702. In addition, the transmission shift register 703 outputs the CRC output from CRC encoding unit 701 sequentially 1 bit by 1 bit to the frame format shaping output control unit 702 subsequent to the transmission frame data 22.

The both rising and falling edge detection circuit 704 detects each of a rising edge and a falling edge of the reception data input (RxD) 30. When detecting either of the rising edge and the falling edge, the both rising and falling edge detection circuit 704 outputs a bit resynchronization trigger signal 713 to the bit resynchronization control unit 705. As shown in FIG. 11, the both rising and falling edge detection circuit 704 performs an XOR operation of a logical value of an arbitrary bit of the reception data input (RxD) 30 and a logical value of a bit next to the arbitrary bit by an XOR circuit, and thereby detects that the logical values of the respective bits are different from each other, and that the rising edge or the falling edge has been generated. That is, the both rising and falling edge detection circuit 704 inputs the logical values of the respective bits to the XOR circuit, and outputs to the bit resynchronization control unit 705 as the bit resynchronization trigger signal 713 a High signal output from the XOR circuit when the logical values of the respective bits are different from each other.

The bit resynchronization control unit 705 outputs a bit timing signal 714 to the bit sampling unit 706 for each sample point. In addition, the bit resynchronization control unit 705 performs resynchronization according to the bit resynchronization trigger signal 713 output from the both rising and falling edge detection circuit 704. That is, the bit resynchronization control unit 705 corrects a sample point based on an output timing of the bit resynchronization trigger signal 713, using as a trigger an output of the bit resynchronization trigger signal 713 from the both rising and falling edge detection circuit 704. According to the above, resynchronization can be performed also in the rising edge in addition to the falling edge in the embodiment 2.

When the bit timing signal 714 is output from the bit resynchronization control unit 705, the bit sampling unit 706 samples a logical value 712 of a bit having output from the flip-flop group 709 of the reception data input (RxD) 30. The bit sampling unit 706 sequentially outputs a sampled logical value 715 to the reception shift register 707. That is, the reception data input (RxD) 30 sampled by the bit sampling unit 706 is output sequentially 1 bit by 1 bit to the reception shift register 707.

The reception shift register 707 outputs the reception data input (RxD) 30 output from the bit sampling unit 706 sequentially 1 bit by 1 bit to the CRC decoding and stuff bit removing unit 708.

The CRC decoding and stuff bit removing unit 708 removes the stuff bit defined by the CAN protocol from the reception data input (RxD) 30 output from the reception shift register 707. The CRC decoding and stuff bit removing unit 708 performs CRC check based on the reception frame data in which the stuff bit has been removed from the reception data input (RxD) 30. When detecting an abnormality by the CRC check, the CRC decoding and stuff bit removing unit 708 outputs an abnormality notification signal 716 to notify of the abnormality to the protocol control state machine 710. The CRC decoding and stuff bit removing unit 708 removes the CRC from the reception frame data after the CRC check. The CRC decoding and stuff bit removing unit 708 outputs the reception frame data 23 in which the CRC has been removed to the extended stuff bit control unit 4.

The flip-flop group 709 includes a plurality of flip-flops for preventing metastable propagation. The flip-flop group 709 outputs the reception data input (RxD) 30 output from the bus transceiver 14 sequentially 1 bit by 1 bit to the both rising and falling edge detection circuit 704 and the bit sampling unit 706.

The protocol control state machine 710 outputs the abnormality notification signal 26 to the error management unit 3 according to an output of the abnormality notification signal 716 from the CRC decoding and stuff bit removing unit 708.

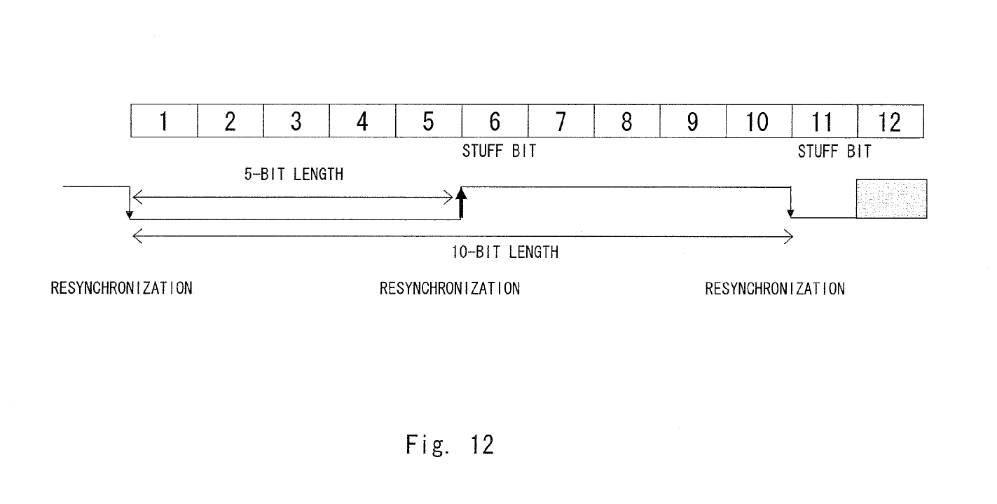

Subsequently, a mechanism and effects of the embodiment 2 will be described with reference to FIG. 12. As shown in FIG. 12, in a worst case where the same logical value continues over 5 bits also after the stuff bit, a worst value of the resynchronization interval was 10 bits since resynchronization was performed only in the falling edge in the CAN protocol pertaining to Patent Literature 1. In contrast with that, in the embodiment 2, the worst value of the resynchronization interval can be shortened to 5 bits by performing resynchronization also in the rising edge.

Consequently, even if a system is constructed by the SSCG, the clock oscillator, etc. that generate the low-precision clock, the effect of the low-precision clock can be reduced. Therefore, also according to the embodiment 2, the CAN communication system can be constructed at low cost using the low-precision clock.

It is to be noted that the present invention is not limited to the above-described embodiments, and it can be appropriately changed without departing from a subject matter. For example, the embodiments 1 and 2 may be implemented in combination.

Although in the embodiment, a case has been exemplified where the CAN communication system is applied to an automobile, the present invention is not limited to this. The CAN communication system may be applied, for example, to ships, industrial equipment.

Although in the embodiment 1, a case has been exemplified where insertion of the stuff bit and identification of the extended stuff bit are performed according to detection of the same logical value continuing over 5 bits, the number of bits is not limited to 5 bits.

Although in the embodiment 1, a case has been exemplified where all the extended stuff bits are overwritten, the present invention is not limited to this. For example, when the logical value before being overwritten of the extended stuff bit is the same as the logical value with which overwriting is performed, overwriting may not be performed.

Although in the embodiment 1, a case has been exemplified where resynchronization is performed according to detection of the falling edge based on the CAN protocol, the present invention is not limited to this. In the case where resynchronization is performed according to detection of the rising edge, even though the above-mentioned processing related to the extended stuff bit is performed, an interval of the rising edge can be shortened, and thus the resynchronization interval can be shortened.

In the embodiment 1, in a case where resynchronization is performed according to detection of the falling edge based on the CAN protocol, even though either bit of High and Low continues over 5 bits, the extended stuff bit is overwritten, but the present invention is not limited to this. For example, in the case where resynchronization is performed according to detection of the falling edge based on the CAN protocol, when the bit of Low of High and Low continues over 5 bits, the extended stuff bit may be overwritten.

This application claims priority based on Japanese Patent Application No. 2011-077032 filed on Mar. 31, 2011, and the entire disclosure thereof is incorporated herein.

### REFERENCE SIGNS LIST

1 CAN controller module
2, 7 Bit stream control unit
3 Error management unit
4 Extended stuff bit control unit
5 Message handler
6 Message buffer memory
10 CAN controller LSI
11 CPU
12 Other peripheral module
13 SSCG
14 Bus transceiver
21 Local bus
22, 24 Transmission frame data
23, 25 Reception frame data
26 Abnormality notification signal
30 Reception data input
31 Transmission data output
41, 42, 43 Clock
100, 200 Node
101 CAN communication system
102 Body-system control node
103 Safety-system control node
104 Information-system control node
105 Engine-system control node
106 Chassis-system control node
401, 410 Same logical value counting unit
402 Extended stuff bit overwriting control unit
403 Redundant data area transmission register
404 Transmission frame register
405, 414 Continuous five bits having same logical value detection signal
406 Transmission frame bit read value
409 Redundant data area reception register
411 Original data restoration control unit
412 Reception frame register
413 Reception frame bit read value
415 Logical value before being overwritten
701 CRC encoding unit
702 Frame format shaping output control unit
703 Transmission shift register
704
705 Bit resynchronization control unit
706 Bit sampling unit
707 Reception shift register
708 CRC decoding and stuff bit removing unit
709 Flip-flop group
710 Protocol control state machine
711 Output data from transmission shift register
712 Logical value 712 of bit of reception data input
713 Bit resynchronization trigger signal
714 Bit timing signal
715 Sampled logical value
716 Abnormality notification signal

1. A CAN communication system comprising:
a transmission apparatus in which when transmitting bit data having a plurality of continuous bits, each of the bits having either a first logical value or a second logical value that is an inversion of the first logical value, the transmission apparatus transmits transmission data instead of the bit data based on a CAN (Controller Area Network) protocol, the transmission data being data in which a stuff bit having an inverted value of the same logical value has been inserted next to the predetermined number of continuous bits having the same logical value in the bit data;
a reception apparatus that executes synchronization processing to synchronize transmission and reception of the transmission data to and from the transmission apparatus according to detection of an edge from the second logical value to the first logical value in the transmission data transmitted from the transmission apparatus based on the CAN protocol, wherein
the transmission apparatus has a transmission control unit that rewrites to the first logical value any of the predetermined number −1 of bits continuing from the predetermined number of continuous bits having the first logical value in the bit data, when transmitting the bit data.

2. The CAN communication system according to claim 1, wherein
the transmission control unit transmits the transmission data with a logical value before being rewritten to the first logical value of any of the bits, and
the reception apparatus has a reception control unit that removes a stuff bit from the transmission data transmitted from the transmission apparatus, and returns the bit rewritten to the first logical value in bit data from which the stuff bit has been removed to the logical value before being rewritten transmitted with the transmission data.

3. The CAN communication system according to claim 1, wherein
the reception apparatus further includes:
an edge detection unit that detects an edge from the second logical value to the first logical value in the transmission data, and outputs an edge detection signal according to detection of the edge; and
a synchronization control unit that executes the synchronization processing according to an output of the edge detection signal from the edge detection unit, wherein
the edge detection unit further detects an edge from the first logical value to the second logical value in the transmission data, and outputs the edge detection signal according to detection of the edge.

4. The CAN communication system according to claim 1, wherein the transmission control unit rewrites to the first logical value a bit next to the predetermined number of continuous bits having the first logical value in the bit data as any of the bits.

5. The CAN communication system according to claim 1, wherein when any of the bits has the second logical value, the transmission control unit suppresses rewriting of the bit to the first logical value.

6. The CAN communication system according to claim 1, wherein the bit data is not more than 79 bits of data from a start of frame to a data field among data frames defined in the CAN protocol.

7. The CAN communication system according to claim 1, wherein the first logical value is Low, and the second logical value is High.

8. A CAN transmission apparatus is the transmission apparatus in which when transmitting bit data having a plurality of continuous bits, each of the bits having either a first logical value or a second logical value, to a reception apparatus that executes synchronization processing to synchronize transmission and reception of the data based on a CAN (Controller Area Network) protocol according to detection of an edge from the second logical value that is an inversion of the first logical value to the first logical value in reception data, the transmission apparatus transmits transmission data instead of the bit data based on the CAN protocol, the transmission data being data in which a stuff bit having an inverted value of the same logical value has been inserted next to the predetermined number of continuous bits having the same logical value in the bit data, wherein
the transmission apparatus has a control unit that rewrites to the first logical value any of the predetermined number −1 of bits continuing from a bit next to the predetermined number of continuous bits having the first logical value in the bit data, when transmitting the bit data.

9. (canceled)

10. A CAN communication method between: a transmission apparatus in which when transmitting bit data having a plurality of continuous bits, each of the bits having either a first logical value or a second logical value that is an inversion of the first logical value, the transmission apparatus transmits transmission data instead of the bit data based on a CAN (Controller Area Network) protocol, the transmission data being data in which a stuff bit having an inverted value of the same logical value has been inserted next to the predetermined number of continuous bits having the same logical value in the bit data; and a reception apparatus that executes synchronous processing to synchronize transmission and reception of the transmission data to and from the transmission apparatus according to detection of an edge from the second logical value to the first logical value in the transmission data transmitted from the transmission apparatus based on the CAN protocol, wherein
when transmitting the bit data, the transmission apparatus rewrites to the first logical value any of the predetermined number −1 of bits continuing from a bit next to the predetermined number of continuous bits having the first logical value continue in the bit data.
